(19) United States
(12) Patent Application Publication
(10) Pub. No.: US 2005/0084205 A1
(43) Pub. Date: Apr. 21, 2005

(54) Wavelength division multiplexing system having built-in optical attenuator

(76) Inventors: Suk Kee Hong, Seoul (KR); Moo Youn Park, Kyungki-do (KR); Yeong Gyu Lee, Suwon (KR)

Correspondence Address: LOWE HAUPTMAN GILMAN & BERNER, LLP, Suite 310, 1700 Diagonal Road, Alexandria, VA, 22314, US

(21) Appl. No.: 10/822,726

(22) Filed: Apr. 13, 2004

(30) Foreign Application Priority Data
Oct. 17, 2003 (KR) 2003-72481

(51) Int. Cl. G02B 6/26; G02B 6/42; G02B 6/00

(52) U.S. Cl. 385/22; 385/15; 385/16; 385/25; 385/47

(57) ABSTRACT

Disclosed is a WDM system for demultiplexing mixed optical signals transmitted through one channel from the outside to distribute specific wavelength optical signals into a plurality of channels. The WDM system has a receiving optical fiber for receiving the mixed optical signals. A filter is arranged in an output end of the receiving optical fiber for selectively transmitting a specific optical signal of a wavelength identical with the peak wavelength of the filter but reflecting remaining wavelength optical signals. A transmitting optical fiber outputs the specific wavelength optical signal transmitted through the filter. A shutter member attenuates the specific wavelength optical signal between the filter and the transmitting optical fiber. An actuator drives the shutter member across the propagation of the specific wavelength optical signal transmitted through the filter; and a control unit for controlling the actuation of the actuator. The built-in optical attenuators allow integration of individual components, simplify the structure of the system as well as improve the performance and reliability of the system.

### BACKGROUND OF THE INVENTION

1. Field of the Invention

The present invention relates to a Wavelength Division Multiplexing (WDM) system adopting a thin film filter in an optical network. In particular, the WDM system of the invention includes built-in optical attenuators in order to integrate individual components, simplify its structure as well as improve performance and reliability.

2. Description of the Related Art

A Wavelength Division Multiplexing system (hereinafter will be referred to as WDM system) functions to distribute optical signals received at one channel to several channels and Vice Versa. The development and application of WDM systems assist optical networks to share massive data volume.

Such a WDM system essentially includes a multiplexer or MUX for mixing a number of signals from several channels to one channel and a demultiplexer or DeMUX for extracting specific wavelength signals from mixed signals and allocating the extracted signals to corresponding channels.

The demultiplexer in the WDM system is divided into two types: First grating type demultiplexer is based upon the principle that optical signals are refracted or reflected variously according to their wavelengths. Second type demultiplexer uses a thin film filter which selectively transmits a specific wavelength signal but reflects other wavelength signals.

FIG. 1 is a perspective view of a WDM system adopting a typical thin film filter, and FIG. 2 is a sectional view of the WDM system shown in FIG. 1.

The WDM system 1 adopting a typical thin film filter as shown in FIG. 1 has a demultiplexer la for demultiplexing optical signals. As shown in FIG. 2, the demultiplexer 1a includes a dual collimator 10 connected with one end of a receiving optical fiber 10a as an input stage, an output-side single collimator 30 connected with an input end of a transmitting optical fiber 30a as an output stage and a filter 20 arranged between the dual collimator 10 and the single collimator 30. The filter 20 selectively transmits an optical signal of a predetermined wavelength (hereinafter will be referred to as “specific wavelength optical signal” or shortly “specific wavelength signal”) to the transmitting optical fiber 30a but reflects remaining wavelength optical signals to a reflecting optical fiber 10b based upon unique transmittances of wavelengths.

The dual collimator 10 includes a dual pig tail 11 and a Grade Index (GRIN) lens 12, in which the dual pig tail 11 fixes the optical fibers 10a and 10b so that the optical signals are introduced in parallel through the optical fiber 10a into the GRIN lens 12, which in turn refracts the optical signals to be collimated on the filter 20. The single collimator 30 includes a GRIN lens 32 and a single pig tail 31 for fixing the transmitting optical fiber 30a so that the specific wavelength optical signal transmitted through the filter 20 without reflection propagates into the output-side transmitting optical fiber 30a.

A glass member 13 is wrapped around the dual pig tail 11 and the GRIN lens 12 to protect the same in a fashion that the input and output optical signals are not attenuated. Also, a glass member 33 is wrapped around the single pig tail 31 and the GRIN lens 32 to protect the same in a fashion that output or specific wavelength optical signal is not attenuated. The glass members 13 and 33 are fixedly positioned within a fixing tube 40, which has vent holes 41 and 42 perforated in front and rear ends to feed nitrogen gas which facilitates curing of epoxy resin used for bonding the dual collimator 10 with the filter 20.

The WDM system 1 having demultiplexers 1a of the above construction includes a plurality of optical attenuators 50 arranged, respectively, downstream of single collimators 30 in respective channels to extract the demultiplexed optical signals. The optical attenuators 50 serve to adjust the quantity of the optical signals in order to reduce the distortion of the optical signals passing through transmitting optical fibers 30a of single collimators 30 as well as enhance the transmittance of the optical signals.

The optical attenuators 50 are connected respectively with the single collimators 30 of the demultiplexers 1a as follows: First, an input-side optical fiber of each optical attenuator 50 is aligned coaxial to an output-side optical fiber of each single collimator 30 in each channel. Then, the optical fiber of the each optical attenuator 50 and the optical fiber of the each single collimator 30 are coupled together through welding with an optical fiber splicer (not shown) in such a fashion that the optical attenuator 50 can adjust the quantity of an optical signal from the single collimator 30 prior to transmission.

However, the demultiplexers 1a and the optical attenuators 50 are separately fabricated and then coupled together at coupling sections 60 via the splicer so that the demultiplexed optical signals can be transmitted from the demultiplexers 1a to the optical attenuators 50. This inevitably makes fabrication and assembly processes complicated to increase cost while requiring a large space for the entire system which in turn acts as an obstacle against size-reduction of products.

Furthermore, the coupling sections 60, where the demultiplexers 1a of the WDM system and the optical attenuators 50 are welded together, function as a source of insertion loss in transmission of optical signals thereby lowering the reliability of the products.

### SUMMARY OF THE INVENTION

The present invention has been made to solve the foregoing problems

Therefore it is an object of the present invention to provide a WDM system having built-in optical attenuators, in which each of the optical attenuators is integrally installed in an optical signal path to attenuate an optical signal, which is selectively transmitted through a demultiplexer, in order to simplify the structure and assembly process of the entire system thereby reducing cost and enabling miniature design as well as reduce the insertion loss of the output optical signal through an optical fiber thereby enhancing reliability of products.

According to an aspect of the invention for realizing the object, there is provided a Wavelength Division Multiplexing (WDM) system for demultiplexing mixed optical signals transmitted through one channel from the outside to distribute specific wavelength optical signals into a plurality of channels, comprising: a receiving optical fiber for receiving the mixed optical signals; a filter arranged in an output end of the receiving optical fiber for selectively transmitting a specific optical signal of a wavelength identical with the peak wavelength of the filter but reflecting remaining wavelength optical signals; a transmitting optical fiber for outputting the specific wavelength optical signal transmitted through the filter; a shutter member for attenuating the specific wavelength optical signal between the filter and the transmitting optical fiber; an actuator for driving the shutter member across the propagation of the specific wavelength optical signal transmitted through the filter; and a control unit for controlling actuation of the actuator.

It is preferred that the filter is a dielectric thin film filter.

It is preferred that the shutter member is arranged opposite to an air gap which is formed between the filter and a single GRIN lens for refracting the specific wavelength optical signal transmitted through the filter.

It is preferred that the shutter member is arranged opposite to an air gap which is formed between a single GRIN lens for refracting the specific wavelength optical signal transmitted through the filter and a single pig tail for fixing the transmitting optical fiber.

It is preferred that the actuator is a comb drive type Micro Electro-Mechanical System (MEMS) actuator.

It is preferred that the actuator is a scratch drive type MEMS actuator.

It is preferred that the actuator is provided integrally in a main board having the receiving and transmitting optical fibers.

It is preferred that the control unit is connected with a photodetector for measuring the intensity of the specific wavelength optical signal attenuated by the shutter member and sending the measured intensity value to the control unit.

According to another aspect of the invention for realizing the object, there is provided a Wavelength Division Multiplexing (WDM) system for demultiplexing mixed optical signals transmitted through one channel from the outside to distribute specific wavelength optical signals into a plurality of channels, comprising: a dual collimator having a receiving optical fiber for receiving the mixed optical signals; a filter arranged in an output end of the receiving optical fiber to selectively transmit a specific wavelength optical signal of a wavelength identical with the peak wavelength thereof but reflect remaining wavelength optical signals; a single collimator having a transmitting optical fiber for outputting the specific wavelength optical signal transmitted through the filter; a shutter member arranged between the filter and the single collimator to attenuate the specific wavelength optical signal transmitted through the filter; an Micro Electro-Mechanical System (MEMS) actuator for driving the shutter member across the propagation of the specific wavelength optical signal transmitted through the filter; and a control unit for controlling the actuation of the actuator.

It is preferred that the dual collimator includes a dual pig tail for fixing the receiving optical fiber, a dual GRIN lens attached to an output side of the dual collimator via a transparent adhesive member and a dual glass member for receiving the dual pig tail, and wherein the single collimator includes a single pig tail for fixing the transmitting optical fiber, a single GRIN lens attached to an output side of the single collimator via a transparent adhesive member and a single glass member for receiving the single pig tail.

It is preferred that the shutter member is arranged opposite to an air gap formed in an adhesive member for coaxially connecting a single GRIN lens of the single collimator with the filter.

It is preferred that the shutter member is arranged opposite to an air gap formed in an adhesive member for coaxially connecting a single GRIN lens of the single collimator with a single pig tail of the single collimator.

According to further another aspect of the invention for realizing the object, there is provided a Wavelength Division Multiplexing (WDM) system for demultiplexing mixed optical signals transmitted through one channel from the outside to separate specific wavelength optical signals into a plurality of channels, comprising: a dual collimator having a receiving optical fiber for receiving the optical signals; a filter provided in an output end of the receiving optical fiber and coaxially attached to an output end of the dual collimator to selectively transmit a specific wavelength optical signal of a wavelength identical with the peak wavelength thereof but reflect remaining wavelength optical signals; a single collimator having a transmitting optical fiber for outputting the specific wavelength optical signal transmitted through the filter; a fixing tube having dual and single glass members mounted on both ends thereof to form an air gap between the filter and the single collimator, the dual glass member receiving a dual pig tail of the dual collimator, and the single glass member receiving a single pig tail of the single collimator; a shutter member for attenuating the specific wavelength optical signal transmitted through the air gap; an Micro Electro-Mechanical System (MEMS) actuator for driving the shutter member across the propagation of the specific wavelength optical signal transmitted through the filter; and a control unit for controlling the actuation of the actuator.

It is preferred that the fixing tube has vent holes perforated adjacent to both ends thereof to feed curing gas through the vent holes.

It is preferred that the fixing tube has an opening perforated opposite to the air gap so that the shutter member can move freely through the opening.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a WDM system adopting a typical thin film filter;

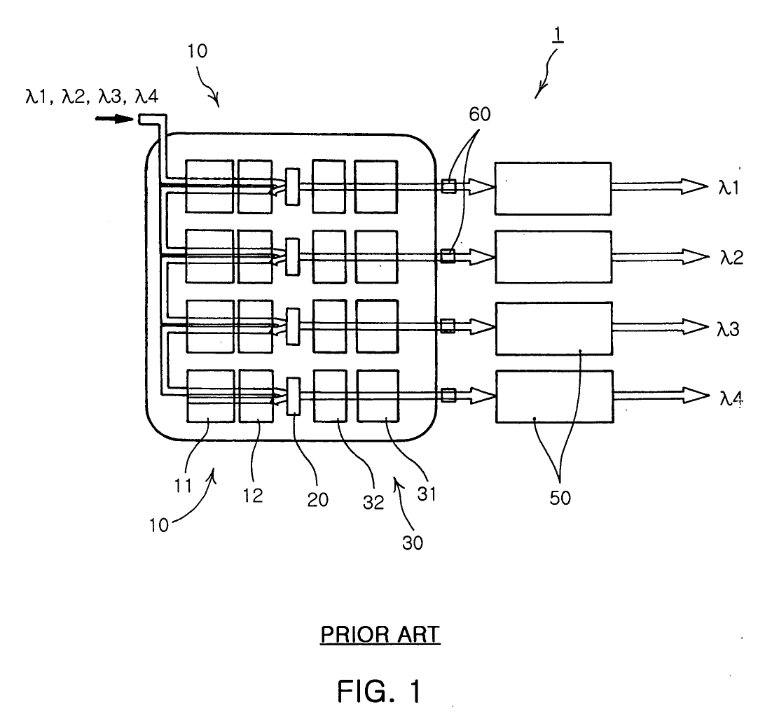

FIG. 2 is a sectional view of the WDM system shown in FIG. 1;

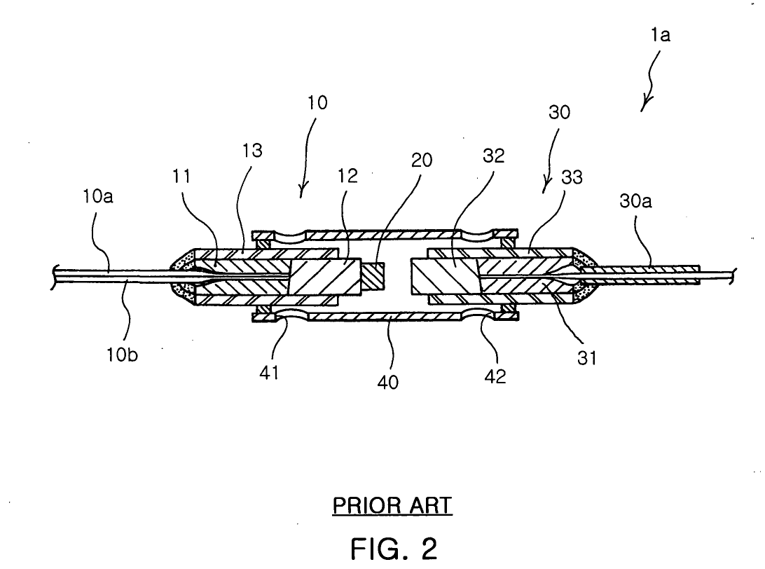

FIG. 3A illustrates the entire structure of a WDM system having built-in optical attenuators according to the invention, in which each shutter member is arranged between a filter and a single GRIN lens;

FIG. 3B is a partial magnification of FIG. 3A;

FIG. 4A illustrates the entire structure of a WDM system having built-in optical attenuators according to the invention, in which each shutter member is arranged between a single GRIN lens and a single pig tail;

FIG. 4B is a partial magnification of FIG. 4A;

FIG. 5A illustrates a WDM system having built-in optical attenuators according to a first embodiment of the invention;

FIG. 5B illustrates a WDM system having built-in optical attenuators according to a second embodiment of the invention.

FIG. 6 illustrates a WDM system having built-in optical attenuators according to a third embodiment of the invention.

### DETAILED DESCRIPTION OF THE PREFERRED EMBODIMENT

A preferred embodiment of the present invention will now be described in detail with reference to the accompanying drawings.

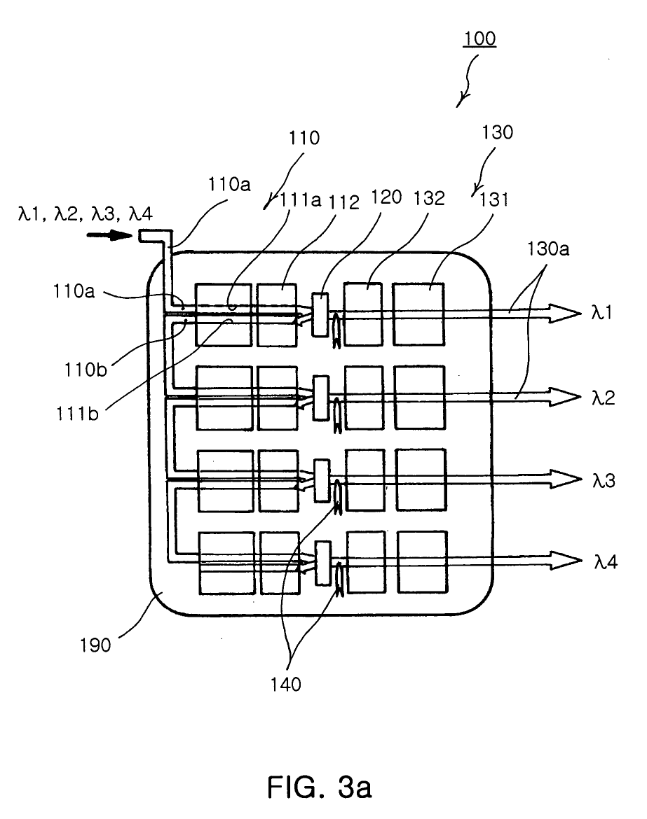

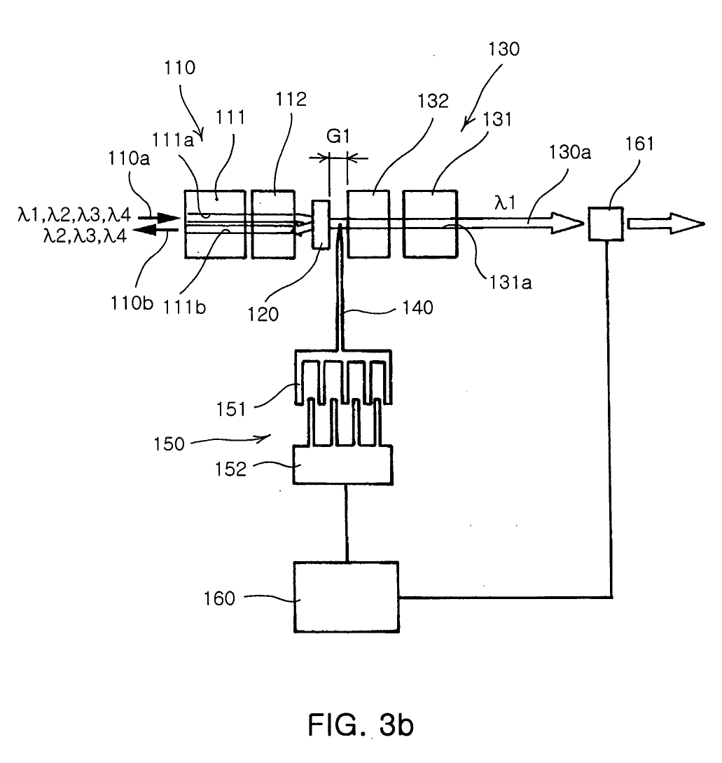

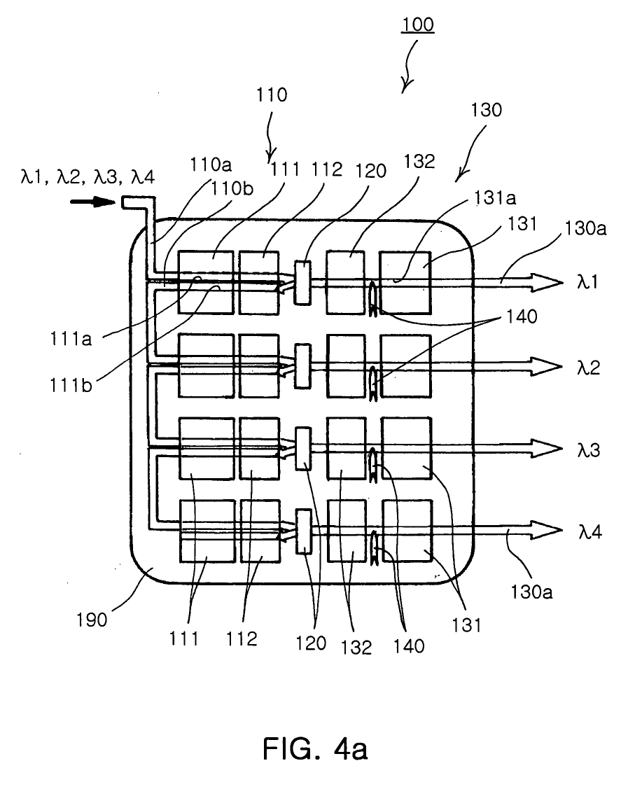

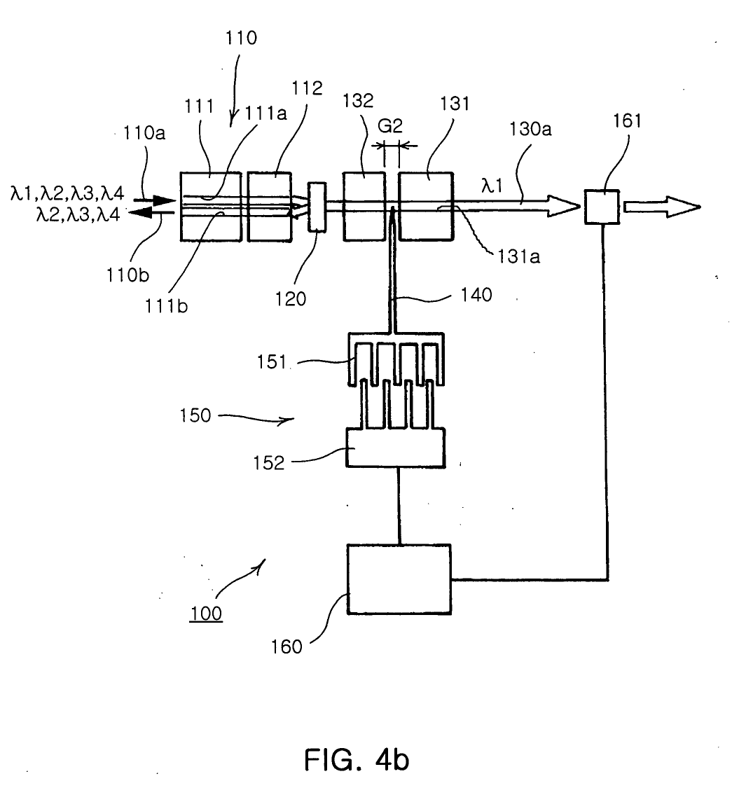

FIG. 3A illustrates the entire structure of a WDM system having built-in optical attenuators according to the invention, in which each shutter member is arranged between a filter and a single GRIN lens, FIG. 3B is a partial magnification of FIG. 3A, FIG. 4A illustrates the entire structure of a WDM system having built-in optical attenuators according to the invention, in which each shutter member is arranged between a single GRIN lens and a single pig tail, and FIG. 4B is a partial magnification of FIG. 4A.

As shown in FIGS. 3A to 4B, the WDM system 100 of the invention includes a multiplexer for multiplexing various optical signals transmitted through a plurality of channels into one channel, demultiplexers for demultiplexing the multiplexed optical signals transmitted through the one channel to extract specific wavelength optical signals separately according to channels and attenuating means incorporated to an internal area of the system 100 for attenuating the quantity of the demultiplxed optical signals before outputting the same. The system 100 includes a receiving optical fiber 110a, filters 120, a transmitting optical fiber 130a, shutter members 140, actuators 150 and a control unit 160.

That is, the receiving optical fiber 110a functions as a channel for receiving mixed optical signals of at least two wavelengths which are introduced from the outside.

The receiving optical fiber 110a is fixed by one of the dual collimators 110 for converting the optical signals incident from a light source (not shown) into parallel light. The dual collimator 110 includes a dual pig tail 111 with a first insertion hole 111a formed through a central body portion thereof to receive the receiving optical fiber 110a and a dual GRIN lens 112 which is arranged coaxial with the dual pig tail 111 to refract the optical signals.

One end of the output-side dual pig tail 111 is formed into an inclined surface of a predetermined angle, and one end of the input-side dual GRIN lens 112 is formed into an inclined surface of a predetermined angle corresponding to the inclined surface of the dual pig tail 111.

The filter 120 is arranged in an output side of the receiving optical fiber 110a of the dual collimator 110, and selectively transmits a specific optical signal having a predetermined wavelength (or specific wavelength optical signal) identical with the peak wavelength thereof but reflects remaining wavelength optical signals.

In the dual pig tail 111 of the dual collimator 110, a second insertion hole 111b is formed adjacent to the first insertion hole 111a, and a reflecting optical fiber 110b is inserted into the insertion hole 111b for allowing the optical signals reflected from the filter 120 to propagate through the same.

The filter 120 is preferably provided in the form of a dielectric thin film filter of fine optical properties such as low insertion loss and high wavelength isolation.

Further, the transmitting optical fiber 130a serves as a channel to externally output only the specific wavelength optical signal transmitted through the filter 120 without reflection.

The transmitting optical fiber 130a is fixed by a single collimator 130, which includes a single pig tail 131 having an insertion hole 131a extended through a central body portion thereof so that the transmitting optical fiber 130a is inserted into the same and a single GRIN lens 132 arranged coaxial with the single pig tail 131 for refracting the specific wavelength optical signal.

The shutter member 140 is arranged in an optical signal-transmitting channel formed between the filter 120 and the single collimator 130 for outputting the transmitted optical signal to reduce the light intensity by damping the optical signal transmitted through the filter 120 placed between the dual collimator 110 and the single collimator 130 or to enhance the reduced light intensity.

As shown in FIGS. 3A and 3B, the shutter member 140 is arranged opposite to an air gap G1 formed between the filter 120 and the single GRIN lens 132 for refracting the specific wavelength optical signal transmitted through the filter 120 on the transmitting optical fiber 130a.

Further, as shown in FIGS. 4A and 4B, a shutter member 140 as above can be arranged in an alternative air gap G2, which is formed between a single GRIN lens 132 for correctly refracting a specific wavelength optical signal transmitted through a filter 120 onto a transmitting optical fiber 130a and a single pig tail 131 for fixing the transmitting optical fiber 130a.

The actuator 150 drives the shutter member 140 forward and backward across the emission of the optical signal transmitted through the filter 120 to regulate the transmission rate of the optical signal.

The actuator 150 is a comb drive type Micro Electro-Mechanical System (MEMS) actuator, and includes a stationary finger section 152 fixed to the top of a main board 190 and a movable finger section 151 connected to one end of a movable stage, which is fixed by the other end to the top of the main board 190. In this circumstance, the shutter member 140 is provided in a leading end of the movable finger section 151.

When bias voltage is applied to the stationary finger section 152 causing forward and backward motion to the movable finger section 151 connected to the movable stage having an elastic piece, the shutter member 140 is driven forward and backward across the propagation of the optical signal according to the movement of the movable finger section 151 so as to attenuate the quantity of the optical signal propagating through the air gap G1 between the filter 120 and the single GRIN lens 132 or the air gap G2 between the single GRIN lens 132 and the single pig tail 131.

Further, the actuator 150 can be in the form of a scratch drive type MEMS actuator.

The control unit 160 controls actuation of the actuator 150 which drives the shutter member 140 across the emission of the optical signal.

The control unit 160 is preferably connected with a photodetector 161 which detects and measures the intensity of the optical signal attenuated by the shutter member 140 and propagating through the transmitting optical fiber 130a to the outside, and sends the detected intensity value to the control unit 160 as a feedback process.

Then, upon receiving the detected intensity value of the optical signal from the photodetector 161, the control unit 160 controls the actuation of the actuator 150 to adjust the position of the shutter member 140.

Preferably, the actuator 150 is provided integral on the main board 190 which is fixed to coaxially place the receiving and transmitting optical fibers 110a and 130a.

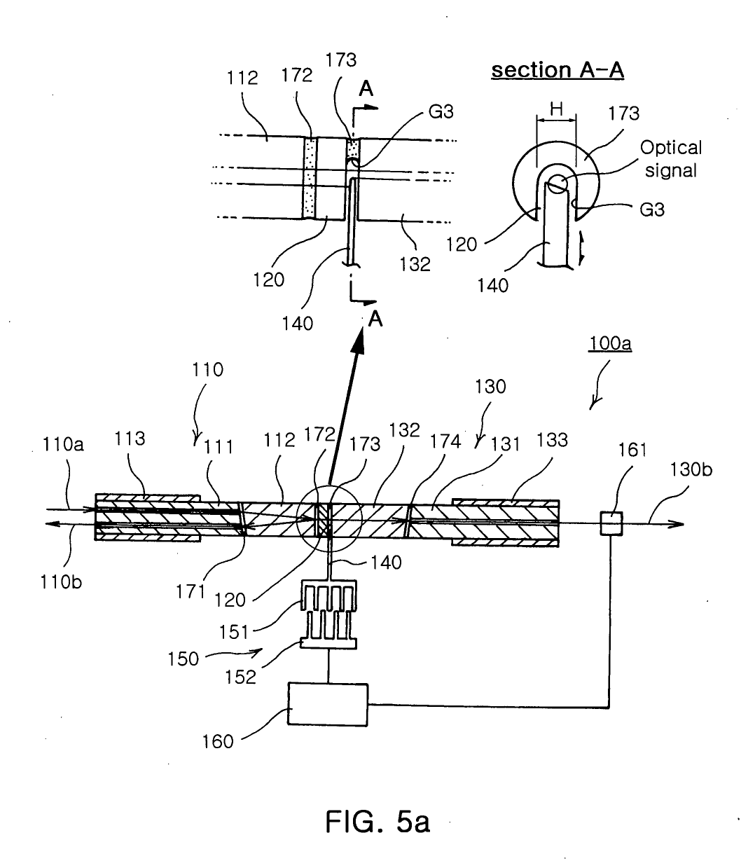

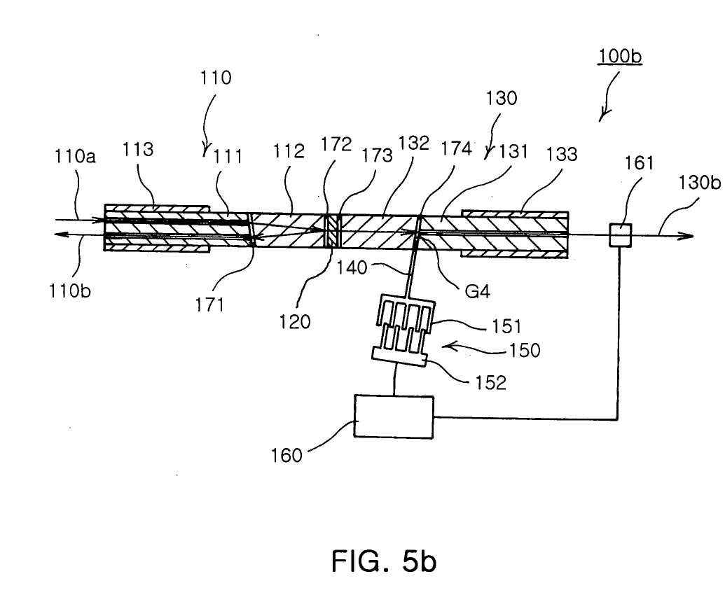

FIG. 5A illustrates a WDM system having built-in optical attenuators according to a first embodiment of the invention, and FIG. 5B illustrates a WDM system having built-in optical attenuators according to a second embodiment of the invention.

Referring to FIGS. 5A and 5B, each of WDM systems 100a and 100b of the invention includes a dual collimator 110, a filter 120 and a single collimator 130, which are arranged coaxially with one another. The dual collimator 110 has a dual pig tail 111 fixing a receiving optical fiber 110a and a dual grin lens 112 attached to an output-side inclination of the dual pig tail 111 via an adhesive member 171. The single collimator 130 has a single pig tail 131 for fixing a transmitting optical fiber 130a and a single grin lens 132 attached to an inclined input end of the single pig tail 131 via an adhesive member 174. The dual and single pig tails 111 and 131 are fixedly inserted respectively into dual and single glass members 113 and 133.

Further, the filter 120 selectively transmits a specific wavelength signal of optical signals introduced through the receiving optical fiber 110a, but reflects remaining wavelength optical signals. The filter 120 is coaxially attached by one end to an output end of the dual grin lens 112 of the dual collimator 110 via an adhesive member 172. The other end or an output end of the filter 120 for outputting the transmitted optical signal is also coaxially attached to an input end of the single GRIN lens 132 of the single collimator 130 via an adhesive member 173.

As shown in FIG. 5A, the adhesive member 173 for coaxially connecting the single GRIN lens 132 of the single collimator 130 with the filter 120 has an air gap G3, and a shutter member 140 for attenuating the optical signal transmitted through the filter 140 is arranged opposite to the air gap G3. The air gap G3 has an outer diameter larger than that of an optical path for the optical signal transmitted through the filter 140 and a height smaller than the outer diameter of the single GRIN lens 132 so that the shutter member 140 can freely move into and out of the air gap G3.

Also as shown in FIG. 5B, the adhesive member 174 for coaxially connecting the single GRIN lens 132 and the single pig tail 131 of the single collimator 130 has an air gap G4, and a shutter member 140 for attenuating the optical signal transmitted through the filter 140 is arranged opposite to the air gap G4. The air gap G4 has an outer diameter larger than that of an optical path for the transmitted optical signal and a height smaller than the outer diameter of the single GRIN lens 132 so that the shutter member 140 can move into and out of the air gap G4.

The adhesive members 171, 172, 173 and 174 are preferably made of a transparent epoxy resin which can transmit optical signals without light loss and create sufficient fixing force when cured.

The shutter member 140 is connected with an actuator 150, which drives the shutter member 140 forward and backward across the emission of the optical signal transmitted through the filter 120 to attenuate the transmission rate of the optical signal. In order to precisely adjust the attenuation of the transmitted optical signal, the forward and backward actuation of the actuator 150 is controlled by a control unit 160.

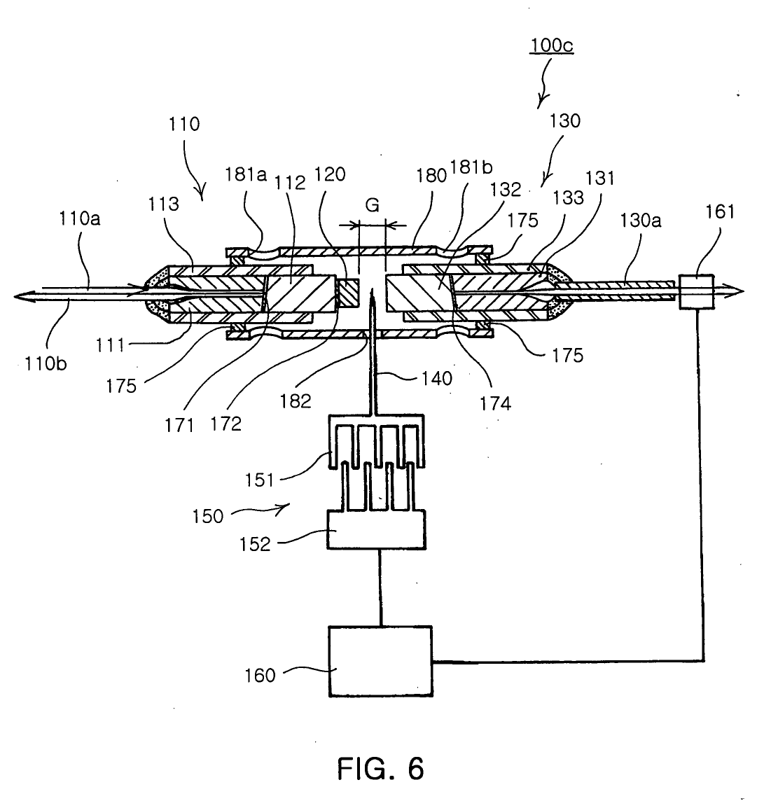

FIG. 6 illustrates a WDM system having built-in optical attenuators according to a third embodiment of the invention.

A WDM system 100c of this embodiment includes a dual collimator 110, a filter 120 and a single collimator 130, which are arranged coaxially with one another. The dual collimator 110 has a dual pig tail 111 for fixing a receiving optical fiber 110a, a dual grin lens 112 attached to an output-side inclination of the dual pig tail 111 via an adhesive member 171 and a hollow dual glass member 113 into which both the dual pig tail 111 and the dual GRIN lens 112 are coaxially inserted. The single collimator 130 has a single pig tail 131 for fixing a transmitting optical fiber 130a, a single grin lens 132 attached to an input-side inclination of the single pig tail 131 via an adhesive member 174 and a hollow single glass member 133 into which both the single pig tail 131 and the single GRIN lens 132 are coaxially inserted.

The dual and single glass members 113 and 133 are inserted into both ends of a hollow fixing tube 180, and fixed to the fixing tube 180 via an adhesive member 175 coated on inner peripheries thereof.

The fixing tube 180 has a plurality of vent holes 181a and 181b perforated at both ends adjacent to the adhesive members 175 so that nitrogen gas can be fed through the vent holes 181a and 181b to rapidly cure the adhesive members 175 coated between the fixing tube 180 and the dual and single collimators 110 and 130.

In an inner space of the fixing tube 180, there is formed an air gap G between the filter 120 attached coaxially to the dual GRIN lens 112 of the dual glass member 113 and the single GRIN lens 132 of the single collimator 130. In the air gap G, a shutter member 140 is freely moved forward and backward to adjust the quantity of an optical signal transmitted through the filter 120.

The air gap G can be adjusted by varying the depth of the dual and single glass members 113 and 133 inserted into the fixing tube 180 through the both ends thereof.

The filter 120 selectively transmits a specific wavelength signal of optical signals introduced through the receiving optical fibers 110a, but reflects remaining wavelength optical signals. The filter 120 is coaxially attached to an output end of the dual grin lens 112 of the dual collimator 110 via an adhesive member 172.

The shutter member 140 is connected with an actuator 150, which drives the shutter member 140 forward and backward across the emission of the optical signal transmitted through the filter 120 to attenuate the transmission rate of the optical signal. In order to precisely adjust the attenuation of the transmitted optical signal, the forward and backward actuation of the actuator 150 is controlled by a control unit 160.

The fixing tube 180 has an opening 182 perforated in a portion thereof opposite to the air gap G3, through which the shutter member 140 moves freely.

The operation of demultiplexing a specific wavelength optical signal from optical signals of mixed wavelength and attenuating the demultiplexed optical signal with the afore-described WDM system of the invention are carried out on the main board 190, as shown in FIGS. 3A and 4A, which includes at least two channels of the dual and single collimators 110 and 130 and the MEMS actuators 150 each provided in each channel.

That is, when mixed optical signals having at least two different wavelengths λ1, λ2, λ3 and λ4 are introduced through the receiving optical fiber 110a of the dual collimator 110 fixed in position on the main board 190, the GRIN lens 111 transmits and reflects the optical signals to be collimated on the filter 120.

A first optical signal of a wavelength λ1 identical with the peak wavelength of the filter 120 propagates through the filter 120 into the single collimator 130, but remaining optical signals of wavelengths λ2, λ3 and λ4 reflect from the filter 120 and propagate into the reflecting optical fiber 110b.

The remaining optical signals of wavelengths λ2, λ3 and λ4 reflected into the reflecting optical fiber 110b in the dual collimator 110 in the first channel are introduced into the dual collimator 110 in the second channel adjacent to the first channel. The dual collimator 110 in the second channel transmits only a specific optical signal of a predetermined wavelength for example λ2 so that remaining optical signals of wavelengths for example λ3 and λ4 are reflected and introduced into the adjacent third channel.

An optical signal transmitted through the filter 120 is attenuated in light quantity by the shutter member 140 which is arranged in the air gap G1 formed between the filter 120 and the single GRIN lens 132 of the single collimator 130 or the air gap G2 formed between the single GRIN lens 132 and the single pig tail 131.

That is, the movement of the shutter member 140 is controlled by the actuator 150 having the stationary finger section 152 and the movable finger section 151. When bias voltage is applied to the stationary finger section 152 connected with an external power supply to cause forward and backward motion to the movable finger section 151, the shutter member 140 mounted on the movable finger section 151 is driven forward and backward across the propagation of the optical signal so as to attenuate the quantity of the optical signal passing through the air gap G, G1 or G3 between the filter 120 and the single GRIN lens 132 or the air gap G2 or G4 between the single GRIN lens 132 and the single pig tail 131.

According to forward and backward movement of the movable stage having an elastic piece, the shutter member 140 mounted on the movable finger section 151 is driven forward and backward across the propagation of an optical signal through the air gap G, G1, G2, G3 or G4 to attenuate the quantity of the optical signal. Then, the attenuated optical signal is outputted through the transmitting optical fiber 130a of the single collimator 130.

Because the photodetector 161 provided in the transmitting optical fiber 130a measures the intensity of the optical signal propagating through the transmitting optical fiber 130a and sends the measured intensity value to the control unit 160 as a feedback process, the control unit 160 can control the movement and thus position of the shutter member 140 through actuation of the actuator 150 based upon the light intensity received from the photodetector 161.

According to the present invention as set forth above, the WDM system for demultiplexing a specific wavelength optical signal from mixed optical signals of various wavelengths incorporates the shutter member to an inner region thereof to attenuate the quantity of the specific wavelength optical signal before outputting the same. As a result, this can simplify the structure of the entire system and its assembly process thereby reducing cost as well as miniaturizing design.

Further, because it is unnecessary to separately fabricate optical attenuators or weld optical fibers together as in the prior art, the present invention can reduce the insertion loss of optical signals through the optical fibers thereby further raising the reliability of products.

Although the preferred embodiments of the present invention have been disclosed for illustrative purposes, those skilled in the art will appreciate that various modifications, additions and substitutions can be made without departing from the spirit and scope of the invention as disclosed in the accompanying claims.

1. A Wavelength Division Multiplexing (WDM) system for demultiplexing mixed optical signals transmitted through one channel from the outside to distribute specific wavelength optical signals into a plurality of channels, comprising:
a receiving optical fiber for receiving the mixed optical signals;
a filter arranged in an output end of the receiving optical fiber for selectively transmitting a specific optical signal of a wavelength identical with the peak wavelength of the filter but reflecting remaining wavelength optical signals;
a transmitting optical fiber for outputting the specific wavelength optical signal transmitted through the filter;
a shutter member for attenuating the specific wavelength optical signal between the filter and the transmitting optical fiber;
an actuator for driving the shutter member across the propagation of the specific wavelength optical signal transmitted through the filter; and
a control unit for controlling the actuation of the actuator.

2. The WDM system according to claim 1, wherein the filter is a dielectric thin film filter.

3. The WDM system according to claim 1, wherein the shutter member is arranged opposite to an air gap which is formed between the filter and a single GRIN lens for refracting the specific wavelength optical signal transmitted through the filter.

4. The WDM system according to claim 1, wherein the shutter member is arranged opposite to an air gap which is formed between a single GRIN lens for refracting the specific wavelength optical signal transmitted through the filter and a single pig tail for fixing the transmitting optical fiber.

5. The WDM system according to claim 1, wherein the actuator is a comb drive type Micro Electro-Mechanical System (MEMS) actuator.

6. The WDM system according to claim 1, wherein the actuator is a scratch drive type MEMS actuator.

7. The WDM system according to claim 1, wherein the actuator is provided integrally in a main board having the receiving and transmitting optical fibers.

8. The WDM system according to claim 1, wherein the control unit is connected with a photodetector for measuring the intensity of the specific wavelength optical signal attenuated by the shutter member and sending the measured intensity value to the control unit.

9. A Wavelength Division Multiplexing (WDM) system for demultiplexing mixed optical signals transmitted through one channel from the outside to distribute specific wavelength optical signals into a plurality of channels, comprising:
a dual collimator having a receiving optical fiber for receiving the mixed optical signals;
a filter arranged in an output end of the receiving optical fiber to selectively transmit a specific wavelength optical signal of a wavelength identical with the peak wavelength thereof but reflect remaining wavelength optical signals;
a single collimator having a transmitting optical fiber for outputting the specific wavelength optical signal transmitted through the filter;
a shutter member arranged between the filter and the single collimator to attenuate the specific wavelength optical signal transmitted through the filter;
an Micro Electro-Mechanical System (MEMS) actuator for driving the shutter member across the propagation of the specific wavelength optical signal transmitted through the filter; and
a control unit for controlling the actuation of the actuator.

10. The WDM system according to claim 9, wherein the dual collimator includes a dual pig tail for fixing the receiving optical fiber, a dual GRIN lens attached to an output side of the dual collimator via a transparent adhesive member and a dual glass member. for receiving the dual pig tail, and wherein the single collimator includes a single pig tail for fixing the transmitting optical fiber, a single GRIN lens attached to an output side of the single collimator via a transparent adhesive member and a single glass member for receiving the single pig tail.

11. The WDM system according to claim 9, wherein the shutter member is arranged opposite to an air gap formed in an adhesive member for coaxially connecting a single GRIN lens of the single collimator with the filter.

12. The WDM system according to claim 9, wherein the shutter member is arranged opposite to an air gap formed in an adhesive member for coaxially connecting a single GRIN lens of the single collimator with a single pig tail of the single collimator.

13. A Wavelength Division Multiplexing (WDM) system for demultiplexing mixed optical signals transmitted through one channel from the outside to separate specific wavelength optical signals into a plurality of channels, comprising:
a dual collimator having a receiving optical fiber for receiving the optical signals;
a filter provided in an output end of the receiving optical fiber and coaxially attached to an output end of the dual collimator to selectively transmit a specific wavelength optical signal of a wavelength identical with the peak wavelength thereof but reflect remaining wavelength optical signals;
a single collimator having a transmitting optical fiber for outputting the specific wavelength optical signal transmitted through the filter;
a fixing tube having dual and single glass members mounted on both ends thereof to form an air gap between the filter and the single collimator, the dual glass member receiving a dual pig tail of the dual collimator, and the single glass member receiving a single pig tail of the single collimator;
a shutter member for attenuating the specific wavelength optical signal transmitted through the air gap;
an Micro Electro-Mechanical System (MEMS) actuator for driving the shutter member across the propagation of the specific wavelength optical signal transmitted through the filter; and
a control unit for controlling the actuation of the actuator.

14. The WDM system according to claim 13, wherein the fixing tube has vent holes perforated adjacent to both ends thereof to feed curing gas through the vent holes.

15. The WDM system according to claim 13, wherein the fixing tube has an opening perforated opposite to the air gap so that the shutter member can move freely through the opening.
